(19) United States
(12) Patent Application Publication
(10) Pub. No.: US 2024/0160473 A1
(43) Pub. Date: May 16, 2024

(54) SYSTEM AND METHOD FOR RADIO ACCESS NETWORK BASEBAND WORKLOAD TRAFFIC PATTERN AWARE SCHEDULING

(71) Applicants: Altiostar Networks India Private Limited, Bangalore (IN); Altiostar Networks, Inc., Tewksbury, MA (US)

(72) Inventors: Ronak Bharatkumar LALWALA, Bangalore (IN); Raghunath Hariharan, Tewksbury, MA (US); Mruthyunjaya Navali, Tewksbury, MA (US)

(73) Assignees: Altiostar Networks India Private Limited, Bangalore (IN); Altiostar Networks, Inc., Tewksbury, MA (US)

(21) Appl. No.: 18/496,022

(22) Filed: Oct. 27, 2023

(30) Foreign Application Priority Data
Nov. 10, 2022 (IN) 202241064209

(51) Int. Cl. G06F 9/48; G06F 1/3296

(52) U.S. Cl. CPC G06F 9/4881; G06F 1/3296

(57) ABSTRACT

An apparatus for idle state central processing unit (CPU) core transitioning includes at least one memory storing instructions, and at least one processor configured to execute the instructions to determine a first slot of a slot pattern in which a task of a first type is scheduled to be performed, assign at least one task of the first type to be performed by at least one first CPU core allocated to perform tasks of the first type, determine a second slot of the slot pattern in which a task of the first type is not scheduled to be performed, and transition the at least one first CPU from an active state to an idle state after at least the second slot of the slot pattern.

### CROSS-REFERENCE TO RELATED APPLICATION(S)

This application is based on and claims priority to Indian Patent Application No. 202241064209, filed on Nov. 10, 2022, in the India Patent Office, the disclosure of which is incorporated herein by reference in its entirety.

### BACKGROUND

### 1. Field

Apparatuses and methods consistent with example embodiments of the present disclosure relate to resource allocation in a radio access network (RAN).

### 2. Description of Related Art

In related art, radio access network (RAN) functions, such as distributed units (DUs), incorporate central processing unit (CPU) intensive baseband processing applications and utilize hyperthreading to enhance application performance and utilization. However, application task allocation to cores may not be aware of idle periods occurring in traffic patterns, and thus the idle state may be entered non-optimally, causing utilization inefficiencies.

### SUMMARY

According to embodiments, systems and methods are provided for transitioning cores of central processing units (CPUs) to idle states based on traffic patterns.

According to an aspect of the disclosure, an apparatus for idle state central processing unit (CPU) core transitioning may include at least one memory storing instructions, and at least one processor configured to execute the instructions to determine a first slot of a slot pattern in which a task of a first type is scheduled to be performed, assign at least one task of the first type to be performed by at least one first CPU core allocated to perform tasks of the first type, determine a second slot of the slot pattern in which a task of the first type is not scheduled to be performed, and transition the at least one first CPU from an active state to an idle state after at least the second slot of the slot pattern.

According to an aspect of the disclosure, a method for idle state CPU transitioning may include determining a first slot of a slot pattern in which a task of a first type is scheduled to be performed, assigning at least one task of the first type to be performed by at least one first CPU core allocated to perform tasks of the first type, determining a second slot of the slot pattern in which a task of the first type is not scheduled to be performed, and transitioning the at least one first CPU from an active state to an idle state after at least the second slot of the slot pattern.

According to an aspect of the disclosure, a non-transitory computer-readable storage medium may store instructions that, when executed by at least one processor, cause the at least one processor to determine a first slot of a slot pattern in which a task of a first type is scheduled to be performed, assign at least one task of the first type to be performed by at least one first CPU core allocated to perform tasks of the first type, determine a second slot of the slot pattern in which a task of the first type is not scheduled to be performed, and transition the at least one first CPU from an active state to an idle state after at least the second slot of the slot pattern.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram showing central processing unit (CPU) allocation;

FIG. 2 is a diagram showing a pooling framework;

FIG. 3 is a diagram showing task event distribution to CPU cores, according to an embodiment;

FIG. 4 is a flowchart of a method for idle state transitioning according to an embodiment;

FIG. 5 is a diagram of an example environment in which systems and/or methods, described herein, may be implemented; and

FIG. 6 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which an idle state duration of central processing unit (CPU) cores may be maximized based on a slot scheduling pattern. For example, the system may determine a slot of a slot pattern in which a first type task is scheduled to be performed (e.g., an uplink (UL) task, a downlink (DL) task, a sounding reference signal (SRS) task, etc.) and assign at least one task of the first type to be performed by a first CPU core, where the first CPU core is allocated to perform tasks of the first type. The system may determine a second slot of the slot pattern in which a task of the first type is not scheduled to be performed. During and/or after the second slot (or slots) and after the first CPU core completes the task(s) of the firs type, the first CPU core may be transitioned to an idle state, and in some examples, may be transitioned to a C-6 long sleep idle state during at least the second slot of the slot pattern.

That is, since the first CPU core is allocated to perform tasks of the first type, and since, in the slot pattern, only certain slots are for scheduling tasks of the first type, the first CPU core may be transitioned to an idle state after the task of the first type is completed and for the duration of the slot pattern in which tasks of the first type are not scheduled to be performed. Tasks of other types may be scheduled during these slots and may be performed by other CPU cores not transitioned to the idle state (e.g., other CPU cores allocated to perform tasks of different types from the first CPU core). Thus, the idle state duration may be extended such that the first CPU core may enter a long sleep state while tasks of other types are performed in these slots by other CPU cores allocated to perform the tasks of the other types. By observing the future slot scheduling in the slot patterns in combination with assignment of particular CPU cores to particular tasks, CPU core idles states may be extended and may increase in frequency, optimizing processing power and reducing operational costs.

Radio access network (RAN) processing may be deployed on servers built with multi-core processors utilizing multi-threading capability to parallelize the workload on cores, saving processing time and improving latency. The hyperthreading technology may enable two logical processors in a single physical processor by replacing, partitioning and sharing the resources of the core. Each of these contexts may be referred to as a logical core, and a software thread may be spawned on each of the logical cores, which the hardware runs in parallel.

In RAN baseband (BB) processing, the system may convert time-domain IQ samples received from radios to bits usable by the media access control (MAC) and vice versa. For over the air radio frequency (RF) communications, the time may be divided into transmission intervals (TTI), all having the same duration. In each TTI, data may be received from radio units, and new data may be prepared to be transmitted to the radio units. Hence, an end-to-end response time may be smaller than a period equal to the TTI duration. If the response data is not ready before the time for the transmission arrives, it may result in response failure.

BB task processing thus has a stricter demand for data transfer and processing latency, and may require real-time scheduling policies for time-critical tasks. BB task pooling frameworks may provide a task dispatching and execution system over a set of CPU resources, such that the workload is automatically balanced across multiple cores. This addresses latency bound processing of software tasks while enabling power saving optimizations. The same mechanisms may be applied to edge could applications, such as computer visions/perception employed in autonomous driving and user interfaces (e.g., augmented reality/virtual reality configurations).

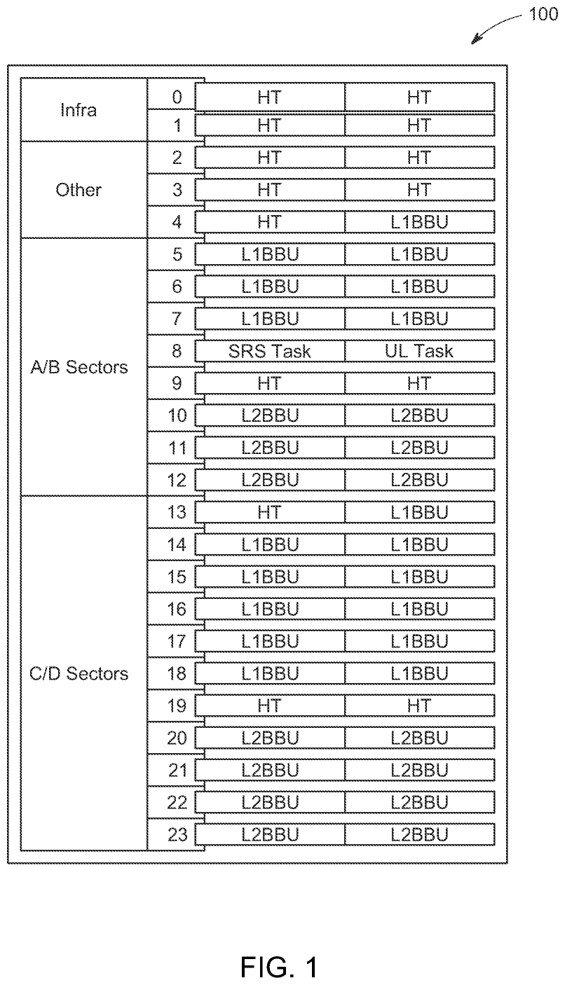

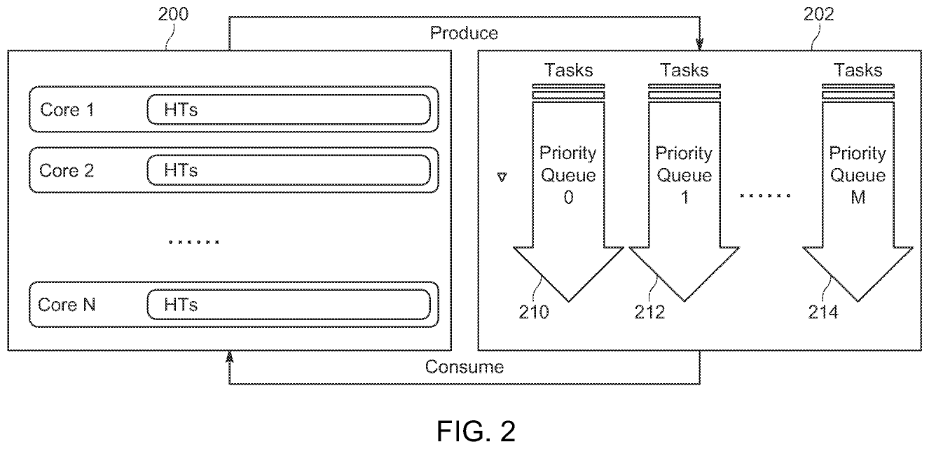

FIG. 1 is a diagram showing CPU allocation. FIG. 2 is a diagram showing a pooling framework. In a RAN, BB processing applications, such as applications that run layer 1 (L1) and layer 2 (L2) processing, may be CPU intensive (e.g., BB processing may utilize about 90% of CPU resources). FIG. 1 is a diagram showing CPU allocation. For example, as shown in FIG. 1, the CPU 100 may include 24 physical cores (i.e., cores 0-23), and each core may include at least two hyperthreads (HTs). That is, the CPU core may correspond to a physical processor/physical core, whereas an HT may correspond to a logical processor/logical core. For example, core 4 may include a first HT allocated for miscellaneous purposes, and an L1 BB unit (BBU) task assigned to a second HT. Core 8 may include two HTs, each assigned an L1 BBU task, core 11 may include two HTs, each assigned an L2 BBU task, etc. The tasks may include UL tasks, DL tasks, SRS tasks, etc.

FIG. 2 is a diagram showing a pooling framework. As shown in FIG. 2, a plurality of cores of a CPU 200, such as Core 1, Core 2, . . . Core N, each may include a real-time (RT) thread (e.g., multiple HTs, each running a software task, such as a RT thread), and a task queue 202, including a first task 210 at priority queue 0, a second task 212 at priority queue 1, and a third task 214 at priority queue M may be implemented. The tasks may be assigned randomly or based on availability to each core and each HTs. As shown in FIG. 2, a plurality of cores of a CPU 200, such as Core 1, Core 2, . . . Core N, each may include a real-time (RT) thread (e.g., multiple HTs), and a task queue 202, including a first task 210 at priority queue 0, a second task 212 at priority queue 1, and a third task 214 at priority queue M may be implemented. As each task arrives in the queue 202, the corresponding task may be randomly assigned to a thread of a core of the CPU 200 based on available HTs or cores. The pooling framework may be statically configured with the CPU cores allocated to it. This list of cores may be changed to resize the CPU list allocated to the pool

However, by allocating various CPU cores to particular tasks, the random assignment and unpredictable CPU usage as a result may be minimized. That is, the system may include a first set of CPU cores allocated for a first task type, a second set of CPU cores allocated for a second task type, and a third set of CPU cores allocated for a third task type. For example, the system may include first CPU cores allocated for UL tasks, second CPU cores allocated for DL tasks, and third CPU cores allocated for SRS tasks. Specific implementations for CPU task allocation can be found in Indian Provisional Application No 202241064325, filed on Nov. 10, 2022, the disclosure of which is incorporated herein by reference.

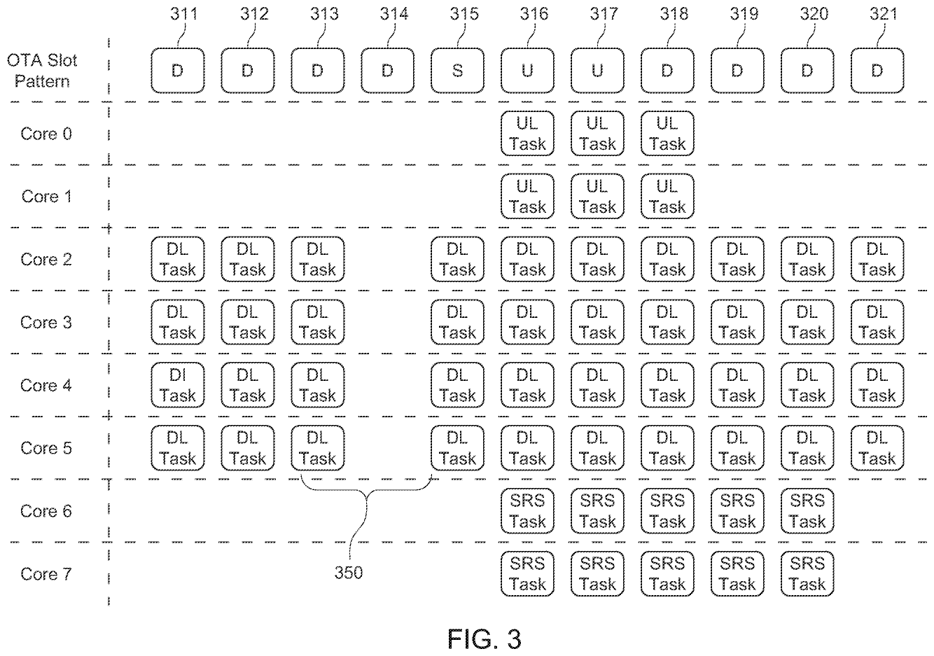

FIG. 3 is a diagram showing task event distribution to CPU cores, according to an embodiment. FIG. 3 depicts an example of a time division duplex (TDD) pattern, although the system may be implemented according to other scheduling patterns. The over-the-air (OTA) slot pattern may include 11 slots, in order of first to fourth DL slots 311-314 (denoted as “D”), a fifth switching slot 315 (denoted as “S”), sixth to seventh UL slots 316-317 (denoted as “U”) and eighth to eleventh downlink slots 318-321 (denoted as “D”). FIG. 3 also depicts tasks being assigned to various cores of a CPU as an example (as depicted, the CPU includes 8 cores, core 0-core 7, although other numbers of cores may be implemented). The cores 0-1 may be allocated to perform UL type tasks, the cores 2-5 may be allocated to perform DL type tasks, and the cores 6-7 may be allocated to perform SRS tasks.

As shown in slots 311-313, DL tasks are being performed by cores 2-5, while cores 0-1 allocated to UL type tasks, as well as cores 6-7 allocated to SRS type tasks may be free during the downlink slots 311-313, such that these cores may be transitioned to an idle state to conserve power and other resources. In downlink slot 314, no tasks may be performed, as the DL type tasks may have been completed and thus cores 2-5 may be transitioned to an idle state. In the scheduling slot 315, DL type tasks may be performed by cores 2-5, while cores 0-1 allocated to UL type tasks, as well as cores 6-7 allocated to SRS type tasks may be free during slot 315, such that these cores may be transitioned to an idle state to conserve power and other resources.

As shown in uplink slots 316-317, UL type tasks may be performed by cores 0-1, DL type tasks may be performed by cores 2-5, and SRS type tasks may be performed by cores 6-7. Depending on the tasks, further processing may be required beyond the uplink slots 316-317. For example in downlink slot 318, UL type tasks may be performed by cores 0-1, as the UL type tasks may still be required to be completed as the system moves to slot 318. In slots 319-320, the UL type tasks may have been completed, such that cores 0-1 may be transitioned to an idle state, while cores 2-5 continue to perform DL type tasks and cores 6-7 continue to perform SRS type tasks. In slot 321, the SRS type tasks may have been completed, such that cores 6-7 may be transitioned to an idle state, while cores 2-5 continue to perform DL type tasks.

In particular, the system may be aware of the TDD slot pattern ahead of time (e.g., N-4 look-ahead scheduling). Accordingly, the system may determine slots of the slot pattern in which particular tasks are to be scheduled, and the schedule idle transition events for CPU cores based on the determination.

For example, referring to FIG. 3, based on the OTA slot pattern, the system may determine that UL tasks are only to be scheduled during slots 316 and 317 of the entire OTA slot pattern. In the example shown in FIG. 3, core 0 and core 1 may be allocated only to perform UL type tasks. Thus, the system may determine that at least the slots after the UL tasks are scheduled, namely, slots 318-312 (and then 311-315 of the next pattern) are potential slots where the UL tasks will be completed. For slots outside of slots 316-317, the system may determine that these slots are slots corresponding to tasks that are not of the UL type. Accordingly, since core 0 and core 1 are only allocated to perform UL type tasks, and no UL type tasks are to be scheduled for the remaining slots 318-321, as well as slots 311-315 of the next block, the system may transition core 0 and core 1 into an idle state (e.g., a long-idle state, a C-6 state, etc.) after the scheduled UL tasks are completed. As shown in FIG. 3, the UL tasks are completed in slot 318, and thus, the system may transition core 0 and core 1 to an idle state for slots 319-321, and slots 311-315 of a following block.

Thus, the system may determine that, once the assigned task of the first type is completed, the CPU core assigned to perform the task may be transitioned to an idle state for a number of slot patterns until the next task of the first type is scheduled. Put alternatively, since the system has allocated a CPU core only to perform tasks of a first type, and since the system has knowledge of the slot pattern schedule, the system may determine that the first CPU core may transition to the idle state for a determined number of slots after the task of the first type is performed, as no other tasks of the first type will be scheduled to the first CPU core and the first CPU core is only allocated to receive tasks of the first type. That is, the first CPU core may be configured to receive only UL tasks, such that, even though DL and SRS tasks are scheduled in other slots, these tasks will not be assigned to the first CPU core, allowing the CPU core to remain in an idle state or deep idle state (e.g., a C-6 state).

Further referring to FIG. 3, cores 2-5 may be allocated to only perform DL tasks, and the system may determine that DL tasks are to be scheduled at slots 311-314 and slots 318-321. However, in slot 313 (e.g. during slot 313), the cores 2-5 may complete the DL task, and the system may determine that no other DL task will be scheduled until at least slot 314. Therefore, the system may transition cores 2-5 to an idle state for the remainder of slot 313 through slot 314 (i.e., in slot 314, a new DL task may be scheduled, but no DL tasks may be performed due to the scheduling and N-4 look-ahead properties). For example, the system may transition the cores 2-5 to an idle state for the time period corresponding to interval 350.

Similarly, referring to FIG. 3, the system may determine that SRS tasks are to be scheduled in slot 315 but not in any other slot. Furthermore, cores 6-7 are allocated to perform only SRS tasks. Accordingly, the system may determine that, after slot 315, cores 6-7 may be transitioned to an idle state after the task scheduled at slot 315 is completed. As shown in FIG. 3, the SRS tasks scheduled at slot 315 are performed through slots 316-320, and the system may transition cores 6-7 to an idle state for slot 321 and for non-SRS scheduling slots of a following scheduling block.

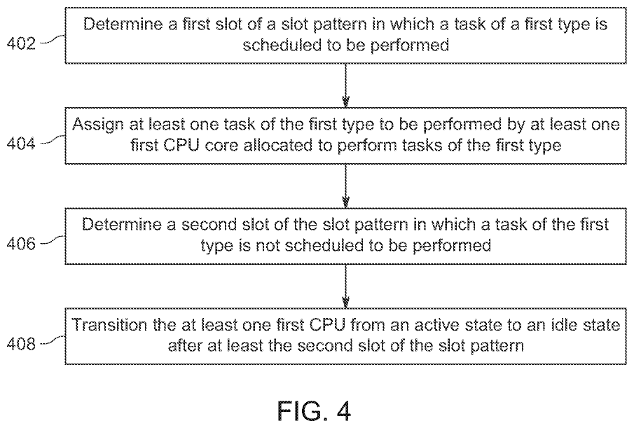

FIG. 4 is a flowchart of a method for idle state transitioning according to an embodiment. In operation 402, the system may determine a first slot of a slot pattern in which a task of a first type is scheduled to be performed. In operation 404, the system may assign at least one task of the first type to be performed by at least one first CPU core allocated to perform tasks of the first type. In operation 406, the system may determine a second slot of the slot pattern in which a task of the first type is not scheduled to be performed. In operation 408, the system may transition the at least one first CPU from an active state to an idle state after at least the second slot of the slot pattern.

By allocating cores to perform particular task types, and using knowledge of a task type scheduling pattern, the provided systems and methods may determine optimal idle state transitioning times and durations for various CPU cores, improving efficiency and efficacy, while conserving power and reducing operation expense.

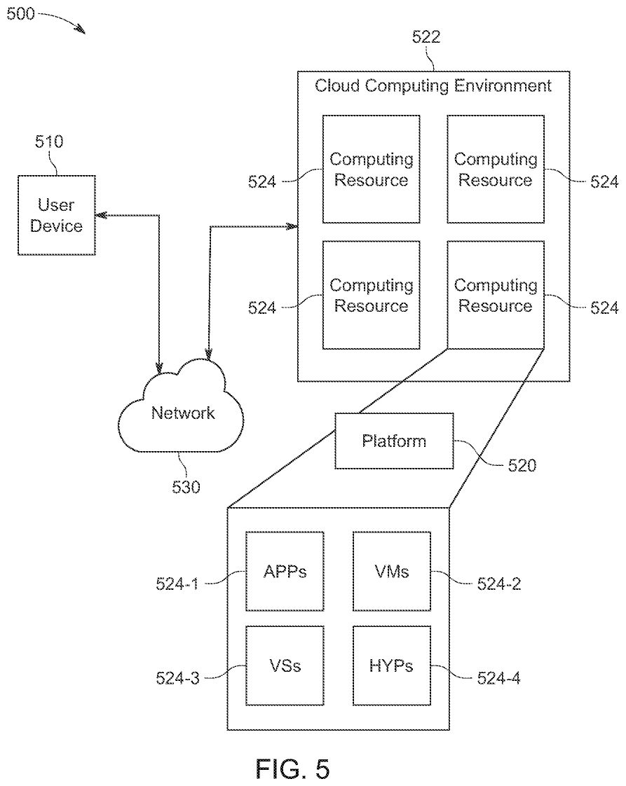

FIG. 5 is a diagram of an example environment 500 in which systems and/or methods, described herein, may be implemented. As shown in FIG. 5, environment 500 may include a user device 510, a platform 520, and a network 530. Devices of environment 500 may interconnect via wired connections, wireless connections, or a combination of wired and wireless connections. In embodiments, any of the functions and operations described with reference to FIG. 1 above may be performed by any combination of elements illustrated in FIG. 5.

User device 510 includes one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520.

Platform 520 includes one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc. services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like.

Application 524-1 includes one or more software applications that may be provided to or accessed by user device 510. Application 524-1 may eliminate a need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems, and may manage the execution of the guest operating systems. Multiple instances of a variety of operating systems may share virtualized hardware resources.

Network 530 includes one or more wired and/or wireless networks. For example, network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

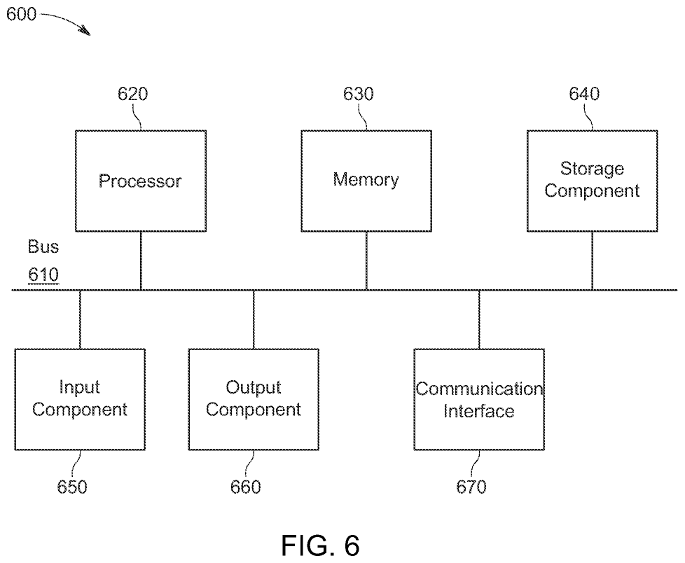

FIG. 6 is a diagram of example components of a device 600. Device 600 may correspond to user device 510 and/or platform 520. As shown in FIG. 6, device 600 may include a bus 610, a processor 620, a memory 630, a storage component 640, an input component 650, an output component 660, and a communication interface 670.

Bus 610 includes a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 includes a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 includes a component that provides output information from device 600 (e.g., a display, a speaker, and/or one or more light-emitting diodes (LEDs)).

Communication interface 670 includes a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

In embodiments, any one of the operations or processes of FIGS. 1-4 may be implemented by or using any one of the elements illustrated in FIGS. 5 and 6.

According to embodiments, an apparatus for idle state CPU core transitioning may include at least one memory storing instructions, and at least one processor configured to execute the instructions to determine a first slot of a slot pattern in which a task of a first type is scheduled to be performed, assign at least one task of the first type to be performed by at least one first CPU core allocated to perform tasks of the first type, determine a second slot of the slot pattern in which a task of the first type is not scheduled to be performed, and transition the at least one first CPU from an active state to an idle state after at least the second slot of the slot pattern.

The second slot of the slot pattern may occur after the assigned at least one task of the first type is scheduled to be completed by the at least one first CPU.

The slot pattern may be a TDD pattern.

The at least one processor may be further configured to determine a third slot of the slot pattern in which a task of a second type is scheduled to be performed and assign at least one task of the second type to be performed by at least one second CPU core during the third slot of the slot pattern.

The at least one processor may be configured to transition the at least one first CPU from the active state to the idle state while the at least one task of the second type is being performed by the at least one second CPU core.

The task of the first type may include an uplink task and the task of the second type may include either a downlink task or a SRS task.

The task of the first type may include a downlink task and the task of the second type may include either an uplink task or a SRS task.

The task of the first type may include a SRS task and the task of the second type may include either an uplink task or a downlink task.

The idle state may correspond to a C-6 long sleep idle state of the at least one first CPU core.

According to embodiments, a method for idle state CPU transitioning may include determining a first slot of a slot pattern in which a task of a first type is scheduled to be performed, assigning at least one task of the first type to be performed by at least one first CPU core allocated to perform tasks of the first type, determining a second slot of the slot pattern in which a task of the first type is not scheduled to be performed, and transitioning the at least one first CPU from an active state to an idle state after at least the second slot of the slot pattern.

The second slot of the slot pattern may occur after the assigned at least one task of the first type is scheduled to be completed by the at least one first CPU.

The slot pattern may be a TDD pattern.

The method may include determining a third slot of the slot pattern in which a task of a second type is scheduled to be performed and assigning at least one task of the second type to be performed by at least one second CPU core during the third slot of the slot pattern.

The transitioning the at least one first CPU from the active state to the idle state may be performed while the at least one task of the second type is being performed by the at least one second CPU core.

The task of the first type may include an uplink task and the task of the second type may include either a downlink task or a SRS task.

The task of the first type may include a downlink task and the task of the second type may include either an uplink task or a SRS task.

The task of the first type may include a SRS task and the task of the second type may include either an uplink task or a downlink task.

The idle state may correspond to a C-6 long sleep idle state of the at least one first CPU core.

According to embodiments, a non-transitory computer-readable storage medium may store instructions that, when executed by at least one processor, cause the at least one processor to determine a first slot of a slot pattern in which a task of a first type is scheduled to be performed, assign at least one task of the first type to be performed by at least one first CPU core allocated to perform tasks of the first type, determine a second slot of the slot pattern in which a task of the first type is not scheduled to be performed, and transition the at least one first CPU from an active state to an idle state after at least the second slot of the slot pattern.

The second slot of the slot pattern may occur after the assigned at least one task of the first type is scheduled to be completed by the at least one first CPU.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. An apparatus for idle state central processing unit (CPU) core transitioning, the apparatus comprising:
at least one memory storing instructions; and
at least one processor configured to execute the instructions to:
determine a first slot of a slot pattern in which a task of a first type is scheduled to be performed;
assign at least one task of the first type to be performed by at least one first CPU core allocated to perform tasks of the first type;
determine a second slot of the slot pattern in which a task of the first type is not scheduled to be performed; and
transition the at least one first CPU from an active state to an idle state after at least the second slot of the slot pattern.

2. The apparatus of claim 1, wherein the second slot of the slot pattern occurs after the assigned at least one task of the first type is scheduled to be completed by the at least one first CPU.

3. The apparatus of claim 1, wherein the slot pattern is a time-division duplex (TDD) pattern.

4. The apparatus of claim 1, wherein the at least one processor is further configured to:
determine a third slot of the slot pattern in which a task of a second type is scheduled to be performed; and
assign at least one task of the second type to be performed by at least one second CPU core during the third slot of the slot pattern.

5. The apparatus of claim 4, wherein the at least one processor is configured to transition the at least one first CPU from the active state to the idle state while the at least one task of the second type is being performed by the at least one second CPU core.

6. The apparatus of claim 4, wherein the task of the first type comprises an uplink task, and
wherein the task of the second type comprises either a downlink task or a sounding reference signal (SRS) task.

7. The apparatus of claim 4, wherein the task of the first type comprises a downlink task, and
wherein the task of the second type comprises either an uplink task or a sounding reference signal (SRS) task.

8. The apparatus of claim 4, wherein the task of the first type comprises a sounding reference signal (SRS) task, and
wherein the task of the second type comprises either an uplink task or a downlink task.

9. The apparatus of claim 1, wherein the idle state corresponds to a C-6 long sleep idle state of the at least one first CPU core.

10. A method for idle state central processing unit (CPU) core transitioning, the method comprising:
determining a first slot of a slot pattern in which a task of a first type is scheduled to be performed;
assigning at least one task of the first type to be performed by at least one first CPU core allocated to perform tasks of the first type;
determining a second slot of the slot pattern in which a task of the first type is not scheduled to be performed; and
transitioning the at least one first CPU from an active state to an idle state after at least the second slot of the slot pattern.

11. The method of claim 10, wherein the second slot of the slot pattern occurs after the assigned at least one task of the first type is scheduled to be completed by the at least one first CPU.

12. The method of claim 10, wherein the slot pattern is a time-division duplex (TDD) pattern.

13. The method of claim 10, further comprising:
determining a third slot of the slot pattern in which a task of a second type is scheduled to be performed; and
assigning at least one task of the second type to be performed by at least one second CPU core during the third slot of the slot pattern.

14. The method of claim 13, wherein the transitioning the at least one first CPU from the active state to the idle state is performed while the at least one task of the second type is being performed by the at least one second CPU core.

15. The method of claim 13, wherein the task of the first type comprises an uplink task, and
wherein the task of the second type comprises either a downlink task or a sounding reference signal (SRS) task.

16. The method of claim 13, wherein the task of the first type comprises a downlink task, and
wherein the task of the second type comprises either an uplink task or a sounding reference signal (SRS) task.

17. The method of claim 13, wherein the task of the first type comprises a sounding reference signal (SRS) task, and
wherein the task of the second type comprises either an uplink task or a downlink task.

18. The method of claim 10, wherein the idle state corresponds to a C-6 long sleep idle state of the at least one first CPU core.

19. A non-transitory computer-readable storage medium storing instructions that, when executed by at least one processor, cause the at least one processor to:
determine a first slot of a slot pattern in which a task of a first type is scheduled to be performed;
assign at least one task of the first type to be performed by at least one first central processing unit (CPU) core allocated to perform tasks of the first type;
determine a second slot of the slot pattern in which a task of the first type is not scheduled to be performed; and
transition the at least one first CPU from an active state to an idle state after at least the second slot of the slot pattern.

20. The apparatus of claim 1, wherein the second slot of the slot pattern occurs after the assigned at least one task of the first type is scheduled to be completed by the at least one first CPU.
